(19) United States
(12) Patent Application Publication
(10) Pub. No.: US 2018/0321138 A1
(43) Pub. Date: Nov. 8, 2018

(54) OPTICAL EXHAUST GAS DETECTION ASSEMBLY WITH REMOTE MOUNTED ELECTRONICS

(71) Applicant: Cummins Inc., Columbus, IN (US)

(72) Inventors: Shu Li, Columbus, IN (US); Alok A. Joshi, Pune (IN); Matthew L. Schneider, Seymour, IN (US); John P. Coates, Newtown, CT (US)

(21) Appl. No.: 15/973,155

(22) Filed: May 7, 2018

Related U.S. Application Data
(60) Provisional application No. 62/502,823, filed on May 8, 2017.

(51) Int. Cl. G01N 21/25; G01N 21/27; G01N 21/15; G01M 15/10

(52) U.S. Cl. CPC G01N 21/255; G01N 21/27; G01N 2201/0873; G01M 15/108; G01N 2201/0636; G01N 21/15

(57) ABSTRACT

An exhaust gas detection assembly, comprising a sensing system comprising a wide-band light source and a detector, a probe configured for mounting in a port of a component of an engine exhaust system, and a fiber optic bundle connected between the sensing system and the probe to carry source light from the light source to the probe and reflected light from the probe to the detector, wherein the detector comprises a filter that passes reflected light received from the probe in a wavelength range corresponding to a wavelength range affected by the presence of a type of gas molecules in the probe.

### CROSS-REFERENCE TO RELATED APPLICATIONS

The present application claims priority to and benefit of U.S. Provisional Patent Application No. 62/502,823, filed May 8, 2017, and entitled “Optical Exhaust Gas detection System with Remote Mounted Electronics,” the entire disclosure of which is incorporated herein by reference.

### TECHNICAL FIELD

Embodiments described herein relate generally to gas sensors and more particularly to optical exhaust gas sensors.

### BACKGROUND

Gas sensors are used to detect the constituents of various gases flowing through various components of internal combustion engines. For example, it is useful to detect pollutants in exhaust gas flowing through aftertreatment systems. Such aftertreatment systems may include gasoline exhaust aftertreatment systems or diesel exhaust aftertreatment systems that include a selective catalytic reduction (SCR) system. Conventional approaches use electrochemical NOx sensors which measure the combined amount of NO, NO₂ and NH₃ in an exhaust stream.

### SUMMARY

In some embodiments, a gas detection assembly for an aftertreatment system receiving exhaust gas comprises a sensing system comprising a wide-band light source and a detector. A probe is configured for mounting in a port of a component of the aftertreatment system. A fiber optic bundle is connected between the sensing system and the probe to carry source light from the wide-band light source to the probe and reflected light from the probe to the detector. The detector comprises a filter that passes reflected light received from the probe in a wavelength range corresponding to a wavelength range affected by the presence of a type of gas molecules of the exhaust gas in the probe.

In some embodiments, an aftertreatment system for reducing constituents of an exhaust gas comprises at least one of a SCR system, an oxidation catalyst, and a particulate filter. The aftertreatment system also comprises a gas detection assembly comprising a sensing system and a probe. The sensing system comprises a wide-band light source and a detector. The probe is operatively coupled to at least one of the SCR system, the oxidation catalyst and the particulate filter. A fiber optic bundle is connected between the sensing system and the probe so as to carry source light from the wide-band light source to the probe and reflected light from the probe to the detector. The detector comprises a filter that passes reflected light received from the probe in a wavelength range corresponding to a wavelength range affected by the presence of a type of gas molecules of the exhaust gas in the probe.

In some embodiments, a method for operating a gas detection assembly for an exhaust gas including a sensing system comprising a wide-band light source and a detector, and at least one probe for detecting gas molecules in the exhaust gas comprises determining an intensity reduction of a reference light wavelength included in a source light reflected by a mirror of the at least one probe. The source light is generated by the wide-band light source. A baseline intensity used by the detector to interpret reflected light is adjusted based on the intensity reduction of the reference light wavelength.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1A is a schematic illustration of an optical exhaust gas detection assembly according to one embodiment of the present disclosure.

FIG. 1B is an end view of a probe of the gas detection assembly of FIG. 1A, according to an embodiment.

FIG. 2A is a schematic illustration of another optical exhaust gas detection assembly, according to an embodiment.

FIG. 2B is a schematic block diagram of a controller that may be included in the gas detection assembly of FIG. 2A, according to an embodiment.

FIGS. 3-5 are graphs showing accuracies of molecule concentrations provided by the system of FIG. 1.

FIG. 6 is a schematic flow diagram of a method for operating a gas detection assembly, according to an embodiment.

While the present disclosure is amenable to various modifications and alternative forms, specific embodiments have been shown by way of example in the drawings and are described in detail below. The present disclosure, however, is not to limit the particular embodiments described. On the contrary, the present disclosure is intended to cover all modifications, equivalents, and alternatives falling within the scope of the appended claims.

### DETAILED DESCRIPTION

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

It is desirable to simultaneously and selectively detect the concentration of each of these and other molecules. Conventional systems use electrochemical sensors to detect constituents of an exhaust gas flowing through an aftertreatment system. Such gases may include NO, NO₂, NH₃, CO, CO₂, total hydrocarbon (THC), emissions etc. While some optical sensors can detect individual molecule concentrations, they generally require pre-processing of the exhaust gas and/or are not suitable for on-engine environments. Thus, it is desirable to provide a gas sensor capable of directly detecting individual molecule concentrations for on-engine applications.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

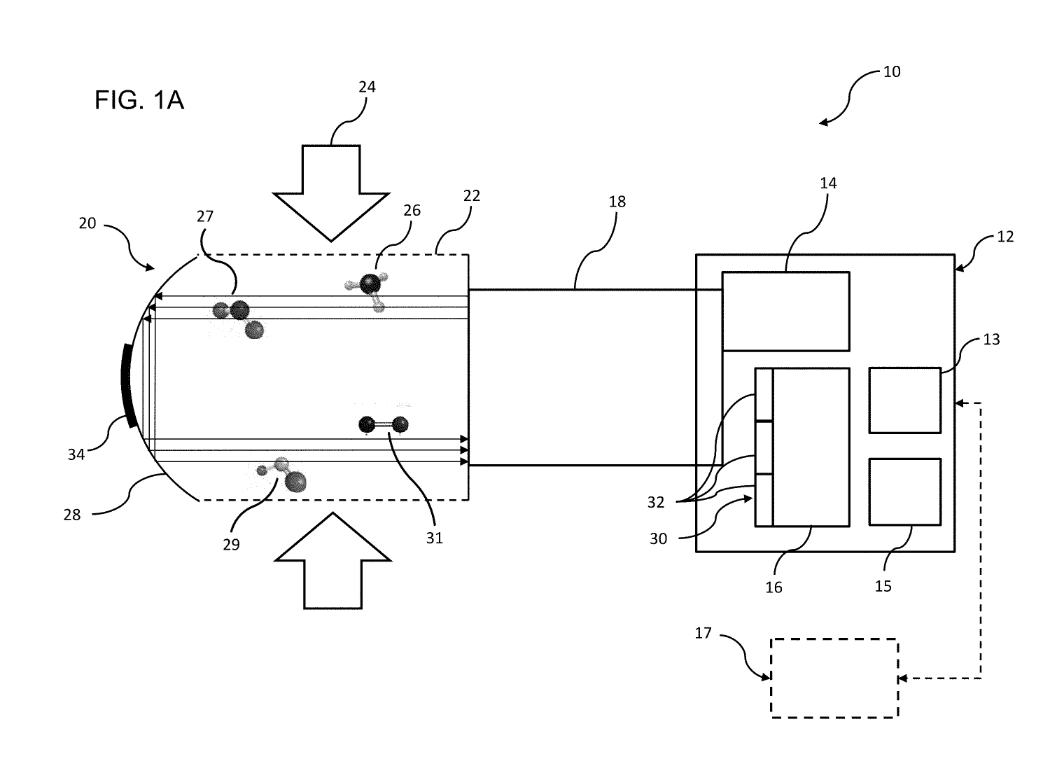

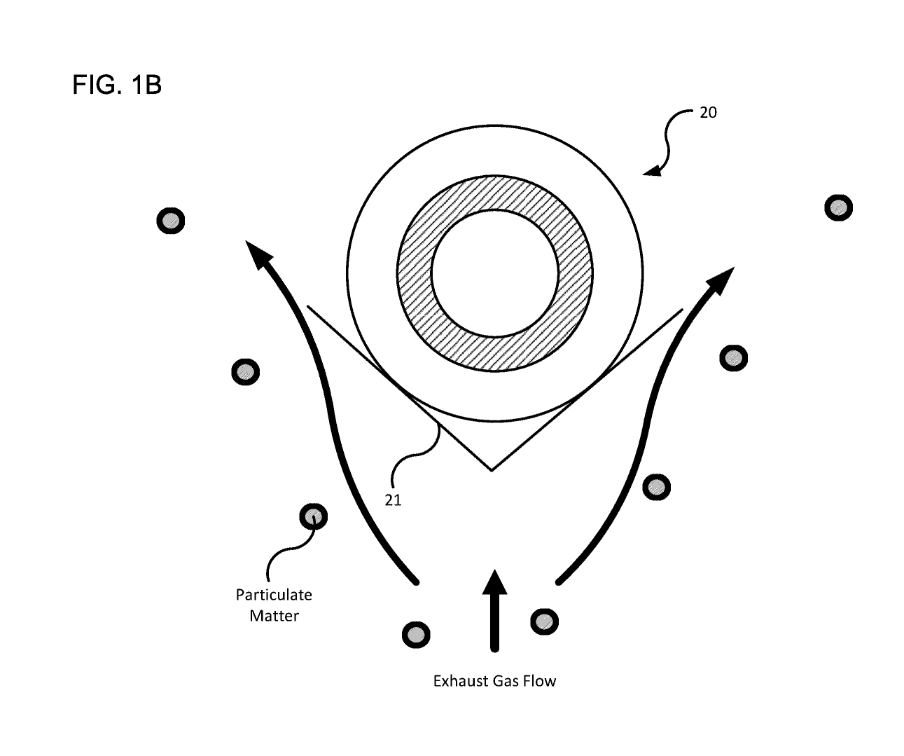

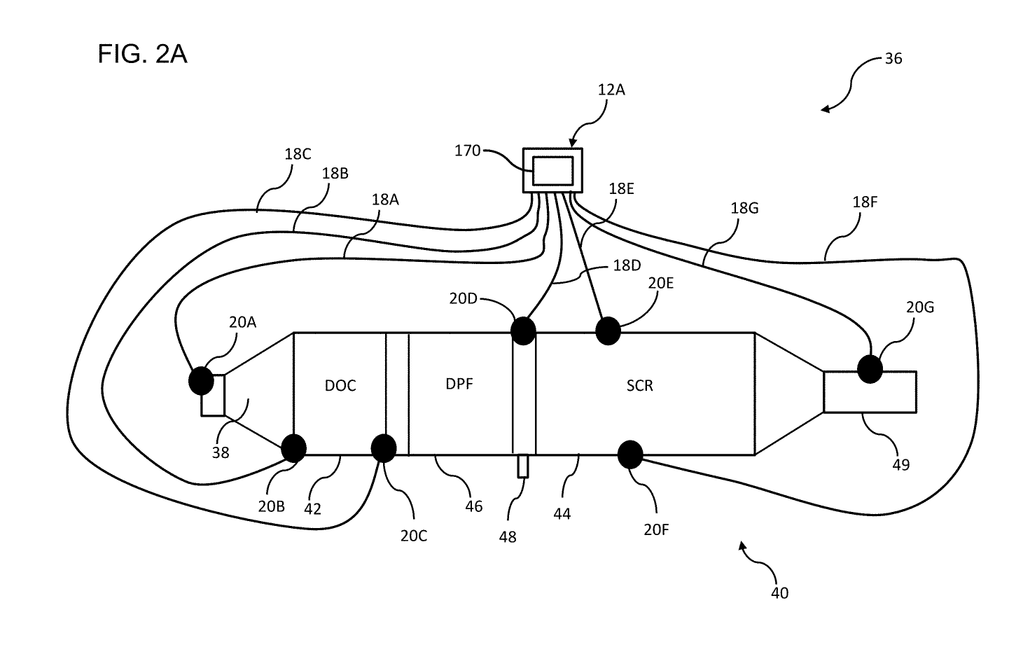

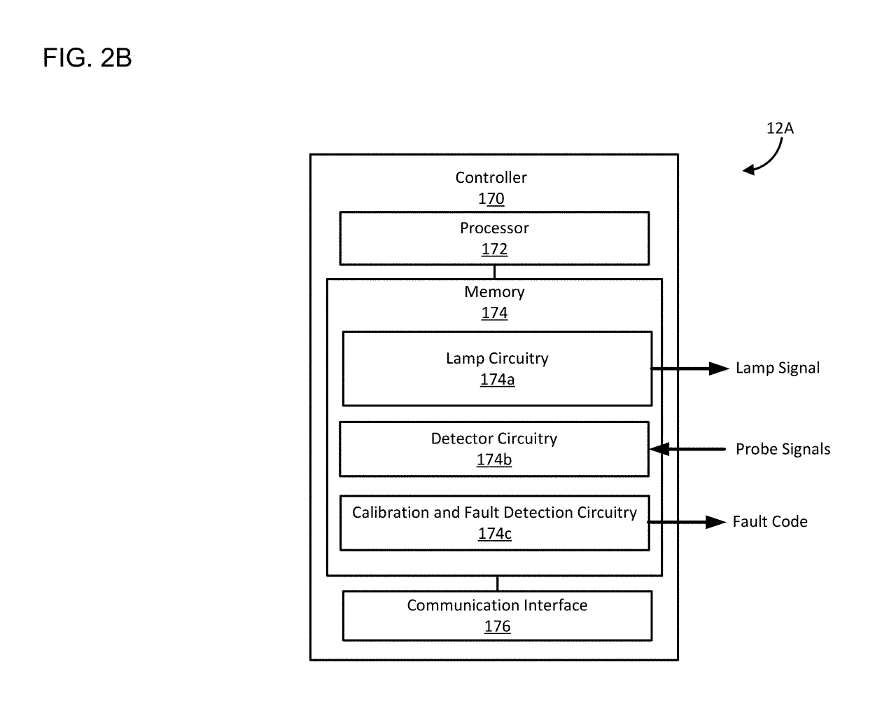

Referring now to FIG. 1A, an embodiment of an optical exhaust gas detection assembly 10 according to the principles of the present disclosure is shown. The gas detection assembly 10 generally includes a sensing system 12 including a lamp or wide-band light source 14 and a detector 16. A probe 20 is configured for mounting in a port of a component of an aftertreatment system (e.g., upstream, on or downstream of an SCR system, a particulate filter and/or an oxidation catalyst included in the aftertreatment system such as the aftertreatment system 40 of FIG. 2A). A fiber optic bundle 18 is connected between sensing system 12 and the probe 20 and configured to carry or transmit source light from the 1 14 to the probe 20 and return reflected light from the probe to the detector. Sensing system 12 is mounted remotely from the high temperature environment in an exhaust application. For example, sensing system 12 may be mounted to a sensor table remote from the engine. In this manner, the electronics of sensing system 12 may be operated in a cooler environment. Sensing system 12 further includes a processing module or controller 13 coupled to detector 16 and memory 15. Processing module 13 is programmable using instructions stored in memory 15 to process the output of detector 16 using the algorithms described herein and to provide output signals to a controller (e.g., an Engine Control Module—ECM 17) for use in engine and system control and diagnostics as described herein.

As is further described below, lamp 14 is a wide-band light source which covers from optical wavelengths from deep UV to near IR wavelengths (e.g., 200-1100 nm). Light is transported from the lamp 14 through the fiber optic bundle 18 into the probe 20.

The probe 20, which is configured for mounting in a port of a conduit of the aftertreatment system, includes a gas-penetrable shroud 22 which permits gas (e.g., exhaust gas) as indicated by arrows 24 to flow into and/or through probe 20. Shroud 22 catalytically oxidizes hydrocarbons that come into contact with the diffusion layer, which may include a layer of shroud 22 where catalytic rare metals are deposited on a porous ceramic substrate similar to an after-treatment catalyst, thereby inhibiting entry of particulate matter (e.g., soot, inorganic particles, debris, etc.) into probe 20 and permitting entry of gas molecules as described below. As the gas flows through light emitted from lamp 14, gas molecules 26, 27, 29, 31 absorb some of the light inside the probe 20. In certain implementations, gas molecules 26, 27, 29, 31 include NO, NO2, NH3 and SO2. Probe 20 further includes a mirror 28 or a plurality of mirrors which reflect the source light back through fiber optic bundle 18 to detector 16 as reflected light. In certain embodiments, probe 20 may also integrate Fiber Bragg Grating to provide high accuracy optical temperature sensing in exhaust temperature ranges (e.g., −40 C to 850 C). In this manner, the gas molecule concentrations output by sensing system 12 may be temperature compensated and conventional exhaust gas temperature sensors may be omitted, thereby reducing the cost of the system.

In some embodiments, the probe 20 may also include a deflector positioned on a surface thereof along a flow path direction of the exhaust gas and configured to redirect particulate matter included in the exhaust gas away from the probe 20. For example, FIG. 1B shows an end view of the probe 20, according to a particular embodiment. A deflector 21 is positioned on a side wall of the probe 20 which faces the exhaust gas flow. The deflector 21 may include two plates (e.g., stainless steel plates) joined together at a point to form a V-shaped structure. In other embodiments, the deflector 21 may include a casted, molded or forged plate. The deflector 21 is positioned on the probe 20 such that the open side of the V-shaped structure of the deflector 21 faces the probe 20 and the closed side faces the exhaust gas flow. Particulate matter (e.g., soot) included in the exhaust gas impacts the deflector 21 and/or is deflected away from the probe 20 by the deflector 21. Preventing particulate matter 20 from impacting the probe 20 may prevent particulate matter buildup on the probe 20, that can reduce a performance of the probe 20 and even lead to failure thereof. Thus the deflector 21 may increase a life of the probe 20.

The detector 16 comprises a filter 32 that passes reflected light received from the probe in a wavelength range corresponding to a wavelength range affected by the presence of a type of gas molecules of the exhaust gas in the probe 20. For example, as is described in more detail below, detector 16 is a multichannel device (e.g., photodiode) which has an array 30 of coatings applied to its surface, each of the filters 32 in the array 30 is configured to pass a different wavelength range of reflected light to the detector 16. In one embodiment of the disclosure, the array includes nine coatings or filters 32 arranged in a three-by-three grid. Each filter 32 permits a certain spectral window of light to pass to detector 16. Thus, the output of detector 16 is essentially an integrated area of absorption peaks within the bounds of the spectral windows (i.e., non-dispersive rather than dispersive). As further described below, various chemometrics algorithms may be used to correlate the integrated intensities to the concentrations of the various gas molecules 26, 27, 29, 31 in the gas 24.

In some embodiments, a plurality of probes are used with a single sensing system. It should be understood that more or fewer probes may be used in certain embodiments and at different locations to provide the various functions described herein and understood by those skilled in the art with the benefit of the teachings of this disclosure. FIG. 2A is a schematic illustration of an aftertreatment system 40 for reducing constituents of an exhaust gas, according to an embodiment. The aftertreatment system 40 includes a SCR system 44, a particulate filter 46 (e.g., a diesel particulate filter (DPF)), an oxidation catalyst 42 (e.g., a diesel oxidation catalyst (DOC)) and a gas detection assembly 36, which may be substantially similar to the gas detection assembly 10. In this example gas detection assembly 36, sensing system 12A is coupled by fiber optic bundles 18A-G to probes 20A-G, respectively. Probe 20A is mounted at an inlet 38 of an exhaust after-treatment system 40. Probe 20B is mounted at an inlet of DOC 42, and probe 20C is mounted at an outlet of DOC 42. Probe 20D is mounted at an inlet of SCR 44 downstream of the DPF 46. Probe 20E is mounted mid-bed of SCR 44, downstream of a reductant injector 48. Probe 20F is also mounted mid-bed of SCR 44. Finally, probe 20G is mounted at tailpipe 49.

Sensing system 12A uses one lamp 14 but a separate detector 16 for each probe 20A-G. More or fewer detectors 16 may be used depending upon the location of probes 20A-G, the size of the array 30 used with the detectors 16, and the type of filters 32 used with the arrays 30. For example, to minimize cost, detectors 16 associated with probes 20A-D mounted upstream of DEF doser 48 may omit filters 32 related to NH₃ sensing from their arrays 30. Depending upon its configuration, module 12A may output four separate concentrations of molecule 26, 27, 29, 31 and provide improved closed-loop engine control (e.g., NO/NO₂ ratio at tailpipe 48), improved fuel quality estimation (e.g., SO₂ concentration), improved catalyst diagnostic (e.g., NO/NO₂ ratio at inlet/outlet of DOC 42 and inlet/mid-bed of SCR 44), estimation of NH₃ surface coverage, NH₃ slip control, and DEF doser diagnostics (e.g., NO, NO₂ and NH₃ concentration at inlet/mid-bed of SCR 44).

More specifically, probe 20A may be used to detect the ratio of NO/NO₂ for use in closed loop combustion control. Moreover, the array 30 associated with probe 20A may also detect the concentration of SO₂ at inlet 38, which may be used to estimate fuel quality, especially in certain markets where the fuel contains undesirable levels of SO₂. Probe 20B may be used to detect the NO/NO₂ ratio at the inlet of DOC 42 and probe 20C may be used to detect the NO/NO₂ ratio at the outlet of DOC 42. With these ratios, the performance of DOC 42 may be assessed. Similarly, probe 20D may be used to detect the concentrations of NO, NO₂ and NH₃ at the inlet of SCR 44, and probe 20E may be used to detect those concentrations mid-bed of SCR 44. With these measurements, the performance of SCR 44 may be assessed by analyzing the NO/NO₂ ratio at its inlet and mid-bed, the amount of NH₃ surface coverage may be estimated, and NH₃ slip may be controlled. Probe 20F may be used to detect the concentrations of NO, NO₂ and NH₃ to permit diagnostics of the reductant injector 48. This may be carried out in combination with the expected reductant inserted as estimated by known insertion control algorithms (e.g., timing of doser actuation, duration of dosing, etc.). If a significant difference between the estimated reductant inserted into the SCR system 44 and the NH₃ level is measured by the sensor, then the reductant injector 44 may have a clogging issue, or the a reductant storage tank level sensor may be malfunctioning and not showing the tank as empty. Finally, probe 20G may be used to detect NO, NO₂ and NH₃ at the outlet of SCR 44 to permit compliance with improved on-board diagnostics capabilities. In this manner, in applications where emissions regulations require monitoring of NOx levels to confirm compliance, the improved speciation of NO, NO₂ and NH₃ at the tailpipe 49 location provides added knowledge of whether a high NOx level as seen by the existing electrochemical sensor is actually caused by inadequate reactions with the NH₃ on the SCR 44, or actually from an NH₃ slip.

Referring again to FIG. 1A, in some embodiments, probe 20 includes an embedded heater 34 to provide a self-cleaning function to the probe. In many applications, probe 20 is mounted in an adverse environment that includes soot, unburned hydrocarbons, sulfates and precipitates that may obscure mirror 28 and interfere with the performance of probe 20. Heater 34 heats mirror 28 sufficiently to burn off or oxidize particulate matter deposits and debris off of the mirror 28 and provide improved accuracy of sensing system 12. A suitable heater 34 is disclosed in U.S. Pat. No. 8,648,322, entitled “OPTICAL SENSING IN AN ADVERSE ENVIRONMENT,” filed Feb. 2, 2011, the entire disclosure of which being expressly incorporated herein by reference.

In some embodiments, a filter 32 of one or more arrays 30 may include a reference filter 32 selected to permit light to pass having a spectrum that is not absorbed by molecules 26, 27, 29, 31. In other words, the reference filter may be configured to allow a reference light wavelength included in the source light reflected by the mirror (i.e., the reflected light) and not absorbed by any of the gas molecules to pass through to the detector 16. As such, the intensity of the light passing through this reference filter 32 should only be affected by solid material deposition (e.g., on mirror 28) or optoelectronic component degradation (e.g., aging of the lens of probe 20). The channel of fiber optic bundle 18 associated with this reference filter 32 may be referred to as a “reference channel.” The reference channel may be used to “auto zero” the detector 16 associated with filter 32, thereby also improving accuracy of sensing system 12. When an intensity reduction is detected on the reference channel (which is unaffected by gas molecules 26, 27, 29, 31), the reduction may accurately be attributed to material deposition (e.g., soot)/component degradation, so eventually sensing system 12 may reset the baseline intensity for the entire spectrum used by detector 16 to account for the effects of deposition/degradation. Moreover, by storing and analyzing the trend of intensity variation of the reference channel over time, diagnostics of sensor can implemented. For example, when normal deposition/degradation as measured by the reference channel reduces the output of detector 16 by one unit every three months, it can readily be determined that a sudden change in the output of one unit per day should generate a failure code or message. In system 26 where multiple probes 20A-G in the exhaust stream are connected to the same sensing system 12A, such diagnostics can be correlated to help pin point the cause of failure. For example, if an unexpected change in light intensity is received from probe 20C at the outlet of DOC 42 but not from probe 20G at tailpipe 49, then it can be determined that lamp 14 of sensing system 12A is functioning as expected and the problem is with the corresponding probe or detector.

In some embodiments, the sensing system 12A may also include a controller 170. The controller 170 may be configured to control the lamp 14 (e.g., an intensity or modulation thereof) and interpret the various light wavelengths included in reflected light detected by the detector 16 after passing through the filter array 30. In some embodiments, the controller 170 may be configured to determine an intensity reduction of the reference light wavelength relative to a baseline intensity of the source light, the intensity reduction corresponding to an amount of particulate matter deposited on the mirror 28. The controller 170 may also be configured to adjust the base line intensity used by the detector 16 to interpret reflected light based on the intensity reduction of the reference light wavelength, or in other words, auto zero the detector 16. In some embodiments, in which the gas detection assembly 20 includes a plurality of probes 20 the controller 170 may also be configured to determine that an intensity reduction of the reference light wavelength received from a first probe included in the plurality of probes 20 is above a predetermined threshold. The controller 170 may be configured to determine if each of the other probes included in the plurality of probes 20 experience an intensity reduction of the reference light wavelength corresponding to the first probe. In response to determining that none of the other probes included in the plurality of probes 20 have experienced the intensity reduction in their reference light wavelength corresponding to the first probe, the controller 170 may determine that the first probe has malfunctioned, and generate a fault code indicating to a user that the first probe has malfunctioned. In other embodiments, in response to determining that each of the other plurality of probes 20 experience the intensity reduction in their reference light wavelength corresponding to the first probe, the controller 170 may be configured to determine that the sensing system 12A (e.g., the lamp 14 and/or the detector 16) has failed, and generate a fault code corresponding to the failure of the sensing system 12A.

In particular embodiments, the controller 170 may be included in a control circuitry. For example, FIG. 2B is a schematic block diagram of a control circuitry 171 that comprises the controller 170, according to an embodiment. The controller 170 comprises a processor 172, a memory 174, or any other computer readable medium, and a communication interface 176. Furthermore, the controller 170 includes a lamp circuitry 174a, a detector circuitry 174b and a calibration and fault detection circuitry 174c. It should be understood that the controller 170 shows only one embodiment of the controller 170 and any other controller capable of performing the operations described herein can be used.

The processor 172 can comprise a microprocessor, programmable logic controller (PLC) chip, an ASIC chip, or any other suitable processor. The processor 172 is in communication with the memory 174 and configured to execute instructions, algorithms, commands, or otherwise programs stored in the memory 174.

The memory 174 comprises any of the memory and/or storage components discussed herein. For example, memory 174 may comprise a RAM and/or cache of processor 172. The memory 174 may also comprise one or more storage devices (e.g., hard drives, flash drives, computer readable media, etc.) either local or remote to controller 170. The memory 174 is configured to store look up tables, algorithms, or instructions.

In one configuration, the lamp circuitry 174a, the detector circuitry 174b and the calibration and the fault detection circuitry 174c are embodied as machine or computer-readable media (e.g., stored in the memory 174) that is executable by a processor, such as the processor 172. As described herein and amongst other uses, the machine-readable media (e.g., the memory 174) facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). Thus, the computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the lamp circuitry 174a, the detector circuitry 174b and the calibration and the fault detection circuitry 174c are embodied as hardware units, such as electronic control units. As such, the lamp circuitry 174a, the detector circuitry 174b and the calibration and the fault detection circuitry 174c may be embodied as one or more circuitry components including, but not limited to, processing circuitry, network interfaces, peripheral devices, input devices, output devices, sensors, etc.

In some embodiments, the lamp circuitry 174a, the detector circuitry 174b and the calibration and the fault detection circuitry 174c may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the lamp circuitry 174a, the detector circuitry 174b and the calibration and the fault detection circuitry 174c may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

Thus, the lamp circuitry 174a, the detector circuitry 174b and the calibration and the fault detection circuitry 174c may also include programmable hardware devices such as field programmable gate arrays, programmable array logic, programmable logic devices or the like. In this regard, the lamp circuitry 174a, the detector circuitry 174b and the calibration and the fault detection circuitry 174c may include one or more memory devices for storing instructions that are executable by the processor(s) of the lamp circuitry 174a, the detector circuitry 174b and the calibration and the fault detection circuitry 174c. The one or more memory devices and processor(s) may have the same definition as provided below with respect to the memory 174 and the processor 172.

In the example shown, the controller 170 includes the processor 172 and the memory 174. The processor 172 and the memory 174 may be structured or configured to execute or implement the instructions, commands, and/or control processes described herein with respect the lamp circuitry 174a, the detector circuitry 174b and the calibration and the fault detection circuitry 174c. Thus, the depicted configuration represents the aforementioned arrangement where the lamp circuitry 174a, the detector circuitry 174b and the calibration and the fault detection circuitry 174c are embodied as machine or computer-readable media. However, as mentioned above, this illustration is not meant to be limiting as the present disclosure contemplates other embodiments such as the aforementioned embodiment where the lamp circuitry 174a, the detector circuitry 174b and the calibration and the fault detection circuitry 174c, or at least one circuit of the lamp circuitry 174a, the detector circuitry 174b and the calibration and the fault detection circuitry 174c are configured as a hardware unit. All such combinations and variations are intended to fall within the scope of the present disclosure.

The processor 172 may be implemented as one or more general-purpose processors, an application specific integrated circuit (ASIC), one or more field programmable gate arrays (FPGAs), a digital signal processor (DSP), a group of processing components, or other suitable electronic processing components. In some embodiments, the one or more processors may be shared by multiple circuits (e.g., the lamp circuitry 174a, the detector circuitry 174b and the calibration and the fault detection circuitry 174c) may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. The memory 174 (e.g., RAM, ROM, Flash Memory, hard disk storage, etc.) may store data and/or computer code for facilitating the various processes described herein. The memory 174 may be communicably connected to the processor 172 to provide computer code or instructions to the processor 172 for executing at least some of the processes described herein. Moreover, the memory 174 may be or include tangible, non-transient volatile memory or non-volatile memory. Accordingly, the memory 174 may include database components, object code components, script components, or any other type of information structure for supporting the various activities and information structures described herein.

The communication interface 176 may include wireless interfaces (e.g., jacks, antennas, transmitters, receivers, communication interfaces, wire terminals, etc.) for conducting data communications with various systems, devices, or networks. For example, the communication interface 176 may include an Ethernet card and port for sending and receiving data via an Ethernet-based communications network and/or a Wi-Fi communication interface for communicating with the a central controller (e.g., an ECM). The communication interface 176 may be structured to communicate via local area networks or wide area networks (e.g., the Internet, etc.) and may use a variety of communications protocols (e.g., IP, LON, Bluetooth, ZigBee, radio, cellular, near field communication, etc.).

The lamp circuitry 174a may be configured to generate a lamp signal configured to activate the lamp 14 causing the lamp to emit the source light. In various embodiments, the lamp circuitry 174a may be configured to control an intensity of the source light emitted by the lamp 14 or a frequency thereof. The detector circuitry 174b may be configured to receive probe signals from each of the plurality of probes 20. The detector circuitry 174b may be configured to interpret the various light wavelengths included in the reflected light received by the detector 16 after passing through the detector, for example, to determine a concentration of the various gas molecules, as previously described herein.

The calibration and fault detection circuitry 174c may be configured to determine an intensity reduction of the reference light wavelength relative to a baseline intensity of the source light, the intensity reduction corresponding to an amount of particulate matter deposited on the mirror 28. The calibration and fault detection circuitry 174c may adjust the base line intensity used by the detector 16 to interpret reflected light based on the intensity reduction of the reference light wavelength, i.e., auto zero the detector 16. The calibration and fault detection circuitry 174c may also be configured to determine that an intensity reduction of the reference light wavelength received from a first probe included in the plurality of probes 20 is above a predetermined threshold. The calibration and fault detection circuitry 174c may be configured to determine if each of the other probes included in the plurality of probes 20 experience an intensity reduction of the reference light wavelength corresponding to the first probe. In response to determining that none of the other probes included in the plurality of probes 20 have experienced the intensity reduction in their reference light wavelength corresponding to the first probe, the controller 170 may determine that the first probe has malfunctioned, and generate a fault code indicating to a user that the first probe has malfunctioned. In other embodiments, in response to determining that each of the other plurality of probes 20 experience the intensity reduction in their reference light wavelength corresponding to the first probe, the calibration and fault detection circuitry 174c may be configured to determine that the sensing system 12A (e.g., the lamp 14 and/or the detector 16) has failed, and generate a fault code corresponding to the failure of the sensing system 12A

It should be apparent from the foregoing that by using a broadband lamp 14, sensing system 12 may be modularized. A different set of species may be measured (e.g., gas quality (CO, CO₂, THC), fuel and oil quality when combined with a tuning fork type sensor, etc.) by simply selecting different filters 32 for array 30 used with detector 16. In some embodiments, the sensing system 12 may also be configured to monitor the concentration of natural gas on the fuel intake side of a dual fuel or pure natural gas engine. In some embodiments, the filters 32 are integrated on detector 16 as a direct coating, which reduces cost compared to stand-alone filters placed in front of detector 16.

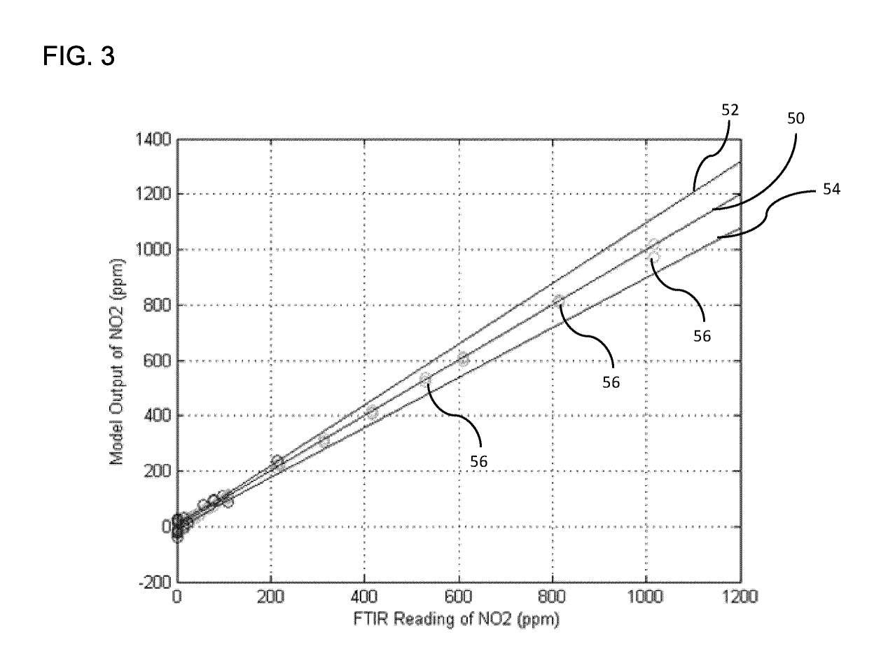

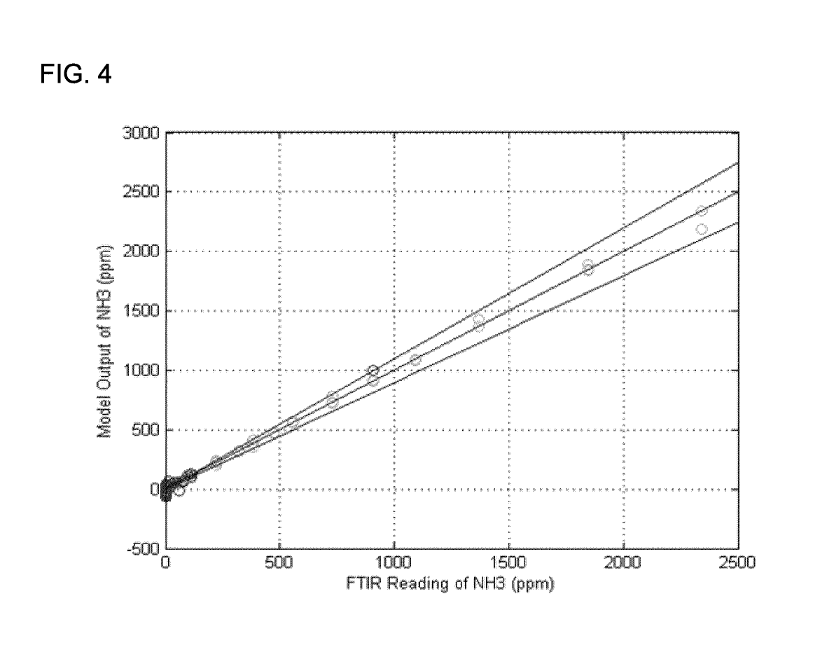

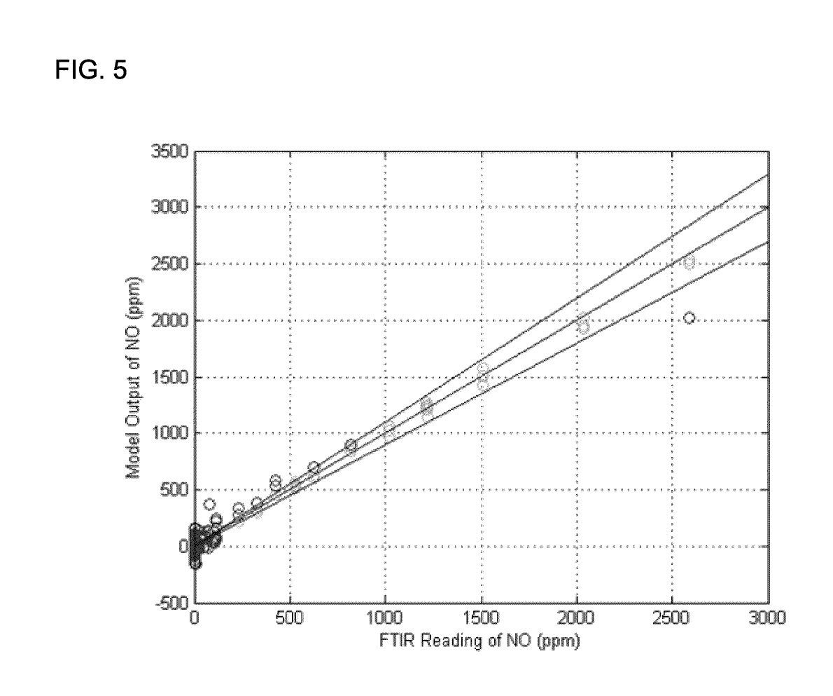

Referring now to FIGS. 3-5, accuracy data is shown for an optical exhaust gas detection assembly according to the principles of the present disclosure. Using commercial chemometric software (Symbion QT Builder provided by Symbion Systems, Inc.) spectral data was correlated with concentrations of target gas molecules 26, 27, 29, 31. More specifically, a Symbion algorithm is used to correlate the integrated intensities for sensing system 12 to the concentrations of gas molecules 26, 27, 29, 31. Various chemometric algorithms using data analytics beyond classical Least Squares may be used, including Partial Least Squares, Principle Component Regression, and Artificial Neural Networks. The Symbion software described herein already includes Partial Least Squares (“PLS”) and Principle Component Regression methods. Specifically, the present disclosure may use the PLS method of Symbion QT Builder for the interpretation of the spectra that are obtained experimentally. In FIG. 3, line 50 represents 100% accuracy of NO2 concentration, line 52 represents a positive error of 10%, and line 54 represents a negative error of 10%. A plurality of actual output values from the algorithm are shown as data points 56. FIG. 4 provides a similar graph for NH3. FIG. 5 provides a similar graph for NO.

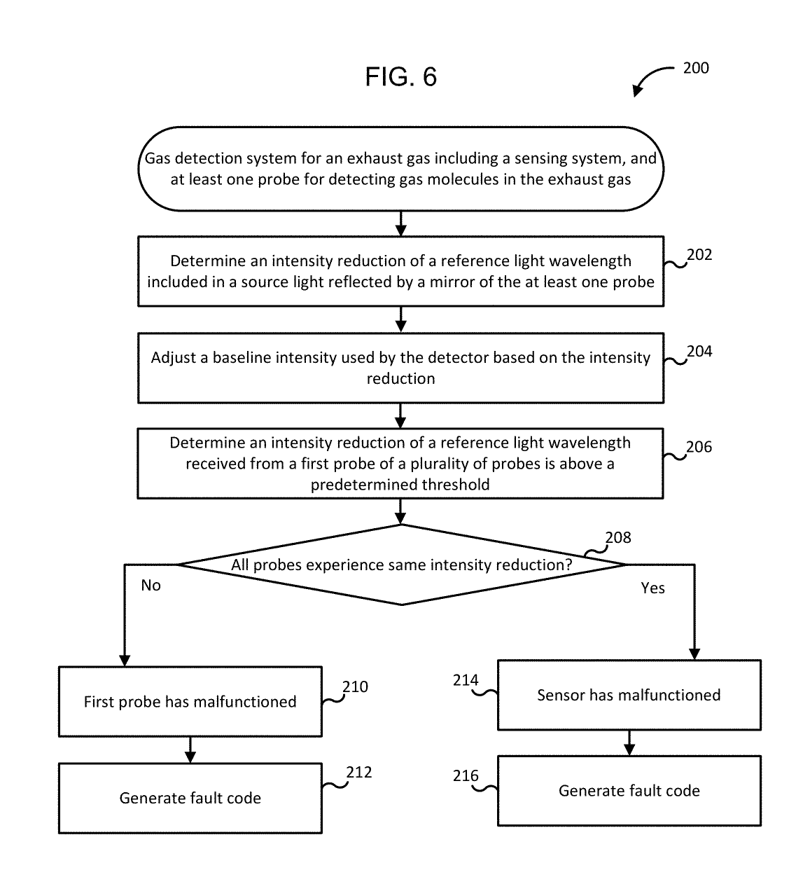

FIG. 6 is a schematic flow diagram of a method 200 for operating a gas detection assembly, for example, the gas detection assembly 10, 36 or any other gas detection assembly described herein, according to an embodiment. Various operations of the method 200 may be implemented with the controller 170, the control circuitry 171 or any other controller described herein.

The method 200 includes determining an intensity reduction of a reference light wavelength included in a source light reflected by a mirror of the at least one probe, at 202. The source light is generated by a wide-band light source (e.g., the lamp 14) included in a sensing system (e.g., the sensing system 12, 12A) of the gas detection assembly (e.g., the gas detection assembly 10, 36). For example, the controller 170 may determine that there is an intensity reduction of the reference light wavelength included in the reflected light from the probe 20. The reference light wavelength includes a wavelength of the source light that is not absorbed by any of the gas molecules and therefore, corresponds to an amount of particulate matter deposited on a mirror 28 of the at least one probe 20 included in the gas detection assembly 10, 36.

At 204, the method includes adjusting a baseline intensity used by the detector to interpret reflected light based on the intensity reduction of the reference light wavelength. For example, the controller 170 may instruct the detector 16 to adjust a baseline intensity (e.g., a baseline intensity of the source light) that the detector 16 was originally calibrated for, using the intensity reduction of the reference light wavelength. For example, the controller 170 may be configured to subtract the intensity reduction of the reference light wavelength from the base line intensity of the source light for determining the baseline intensity to be used by the detector 16 for interpreting the reflected light.

In some embodiments in which the gas detection assembly (e.g., the gas detection assembly 10, 36) comprises a plurality of probes (e.g., the probe 20), the method 200 may also include determining that an intensity reduction of the reference light wavelength received from a first probe included in the plurality of probes is above a predetermined threshold, at 206. For example, the controller 170 may determine that there as an abnormal intensity reduction in the first probe of the plurality of probes 20 (e.g., any one of the probes 20A-F). At 208, it is determined if each of the other probes included in the plurality of probes experience an intensity reduction of the reference light wavelength corresponding to the first probe. For example, the controller 170 may analyze the light intensity of reflected light received from all the other probes included in the plurality of probes 20, and determine if an intensity reduction of their reference light wavelengths is the same as the intensity reduction observed for the first probe.

At 210, in response to determining (e.g., by the controller 170) that none of the other probes included in the plurality of probes (e.g., the probes 20) experience the intensity reduction in their reference light wavelength corresponding to the first probe (208:NO), it is determined that the first probe has malfunctioned. A fault code corresponding to the first probe malfunctioning is generated, at 212 (e.g., by the controller 170).

If it is determined that each of the other plurality of probes experience the intensity reduction in their reference light wavelength corresponding to the first probe (208:YES), it is determined that the sensing system (e.g., the lamp 14 and/or the detector 16 of the sensing system 12, 12A) has malfunctioned, at 214. At 216, a fault code corresponding the sensor system malfunctioning is generated (e.g., by the controller 170).

It should be appreciated that while various embodiments of the gas detection assemblies described herein are described in the context of gas molecule detection in aftertreatment systems, the gas detection assemblies described herein may be used in or with any other system or assembly for detecting gases therein. Such systems may include but are not limited to dissolved gas detection assemblies (e.g., water quality sensors), environmental gas detection assemblies (e.g., atmospheric pollution detectors), soil gas detection assemblies or life support sensing systems (e.g., oxygen, carbon dioxide, nitrogen, etc. monitoring in enclosed habitats).

It should be understood that, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A gas detection assembly for an aftertreatment system receiving exhaust gas, comprising:
a sensing system comprising a wide-band light source and a detector;
a probe configured for mounting in a port of a component of the aftertreatment system; and
a fiber optic bundle connected between the sensing system and the probe to carry source light from the wide-band light source to the probe and reflected light from the probe to the detector;
wherein the detector comprises a filter that passes reflected light received from the probe in a wavelength range corresponding to a wavelength range affected by the presence of a type of gas molecules of the exhaust gas in the probe.

2. The gas detection assembly of claim 1, wherein the source light comprises optical wavelengths in a range of 200 nm to 1,100 nm.

3. The gas detection assembly of claim 1, wherein the probe comprises a gas-penetrable shroud which permits exhaust gas to pass into probe and absorb source light.

4. The gas detection assembly of claim 1, wherein the probe comprises a mirror configured to direct source light from the fiber optic bundle as reflected light to the fiber optic bundle.

5. The gas detection assembly of claim 4, wherein the probe comprises a heater configured to burn particulate matter deposits off of the mirror.

6. The gas detection assembly of claim 1, wherein the probe comprises a deflector positioned on a surface thereof along a flow path direction of the exhaust gas, the deflector configured to redirect particulate matter included in the exhaust gas away from the probe.

7. The gas detection assembly of claim 1, wherein the probe comprises a Fiber Bragg grating configured to measure a temperature of the exhaust gas.

8. The gas detection assembly of claim 1, wherein the detector includes an array of filters, each of the filters in the array being configured to pass a different wavelength range of reflected light to the detector.

9. The gas detection assembly of claim 8, wherein the array of filters comprise a plurality of filter coatings deposited on a surface of the detector in a predetermined array.

10. The gas detection assembly of claim 1, wherein the gas molecules comprise at least one of NO, NO₂, NH₃, or SO₂, CO, CO₂ and total hydrocarbons.

11. An aftertreatment system for reducing constituents of an exhaust gas, comprising:
at least one of:
a selective catalytic reduction system,
an oxidation catalyst, and
a particulate filter; and
a gas detection assembly, comprising:
a sensing system comprising a wide-band light source and a detector,
a probe operatively coupled to at least one of the selective catalytic reduction system, the oxidation catalyst and the particulate filter, and
a fiber optic bundle connected between the sensing system and the probe so as to carry source light from the wide-band light source to the probe and reflected light from the probe to the detector;
wherein the detector comprises a filter that passes reflected light received from the probe in a wavelength range corresponding to a wavelength range affected by the presence of a type of gas molecules of the exhaust gas in the probe.

12. The aftertreatment system of claim 11, wherein the source light comprises optical wavelengths in a range of 200 nm to 1,100 nm.

13. The aftertreatment system of claim 11, wherein the probe comprises a gas-penetrable shroud which permits the exhaust gas to pass into the probe and absorb source light.

14. The aftertreatment system of claim 11, wherein the probe comprises a mirror configured to direct source light from the fiber optic bundle as reflected light to the fiber optic bundle.

15. The aftertreatment system of claim 14, wherein the probe comprises a heater configured to burn particulate matter deposits off of the mirror.

16. The aftertreatment system of claim 11, wherein the gas molecules comprise at least one of NO, NO₂, NH₃, or SO₂, CO, CO₂ and total hydrocarbons.

17. The aftertreatment system of claim 11, wherein the detector includes an array of filters, each of the filters in the array being configured to pass a different wavelength range of reflected light to the detector.

18. The aftertreatment system of claim 17, wherein the array of filters comprise a reference filter configured to allow a reference light wavelength included in the source light reflected by the mirror and not absorbed by any of the gas molecules to pass through to the detector, and wherein the gas detection assembly further comprises a controller configured to:
determine an intensity reduction of the reference light wavelength relative to a baseline intensity of the source light, the intensity reduction corresponding to an amount of particulate matter deposited on the mirror; and
adjust the base light intensity used by the detector to interpret reflected light based on the intensity reduction of the reference light wavelength.

19. The aftertreatment system of claim 18, wherein the gas detection assembly includes a plurality of probes, and wherein the controller is configured to:
determine that an intensity reduction of the reference light wavelength received from a first probe included in the plurality of probes is above a predetermined threshold;
determine if each of the other probes included in the plurality of probes experience an intensity reduction of the reference light wavelength corresponding to the first probe; and
in response to determining that none of the other probes included in the plurality of probes have experienced the intensity reduction in their reference light wavelength corresponding to the first probe, determine that the first probe has malfunctioned.

20. The aftertreatment system of claim 19, wherein the controller is configured to: in response to determining that each of the other plurality of probes experience the intensity reduction in their reference light wavelength corresponding to the first probe, determine that the sensing system has failed.

21. A method for operating a gas detection assembly for an exhaust gas including a sensing system comprising a wide-band light source and a detector, and at least one probe for detecting gas molecules in the exhaust gas, the method comprising:
determining an intensity reduction of a reference light wavelength included in a source light reflected by a mirror of the at least one probe, the source light generated by the wide-band light source; and
adjusting a baseline intensity used by the detector to interpret reflected light based on the intensity reduction of the reference light wavelength.

22. The method of claim 21, wherein the gas detection assembly comprises a plurality of probes and wherein the method further comprises:
determining that an intensity reduction of the reference light wavelength received from a first probe included in the plurality of probes is above a predetermined threshold;
determining if each of the other probes included in the plurality of probes experience an intensity reduction of the reference light wavelength corresponding to the first probe; and
in response to determining that none of the other probes included in the plurality of probes experience the intensity reduction in their reference light wavelength corresponding to the first probe, determining that the first probe has malfunctioned.

23. The method of claim 22, furthermore comprising:
in response to determining that each of the other plurality of probes experience the intensity reduction in their reference light wavelength corresponding to the first probe, determining that the sensing system has failed.
